(19) United States
(12) Patent Application Publication
(10) Pub. No.: US 2025/0005913 A1
(43) Pub. Date: Jan. 2, 2025

(54) IMAGE PROCESSING APPARATUS, IMAGE PROCESSING METHOD, AND PROGRAM

(71) Applicant: NIPPON TELEGRAPH AND TELEPHONE CORPORATION, Tokyo (JP)

(72) Inventors: Kosuke NISHIDA, Tokyo (JP); Kyosuke NISHIDA, Tokyo (JP); Shuichi NISHIOKA, Tokyo (JP)

(73) Assignee: NIPPON TELEGRAPH AND TELEPHONE CORPORATION, Tokyo (JP)

(21) Appl. No.: 18/708,562

(22) PCT Filed: Jun. 24, 2022
(86) PCT No.: PCT/JP2022/025412

§ 371 Date: May 8, 2024

(30) Foreign Application Priority Data
Nov. 12, 2021 (WO) PCT/JP2021/041801

(51) Int. Cl. G06V 10/80; G06V 10/44; G06V 10/74; G06V 10/82

(52) U.S. Cl. CPC G06V 10/806; G06V 10/44; G06V 10/761; G06V 10/82

(57) ABSTRACT

Therefore, an image processing apparatus according to the present disclosure is an image processing apparatus for extracting a feature amount of image data, the image processing apparatus including: an image understanding unit 41 that vectorizes an image pattern of the image data to extract an image feature amount; a text understanding unit 43 that vectorizes a text pattern of attached text data attached to the image data to extract a text feature amount; and a feature amount mixing unit 44 that generates a mixed feature amount as the feature amount by projecting the image feature amount extracted by the image understanding unit 41 and the text feature amount extracted by the text understanding unit 43 onto the same vector space and mixing the image feature amount and the text feature amount.

### TECHNICAL FIELD

The present disclosure relates to an image processing apparatus, an image processing method, and a program.

### BACKGROUND ART

In recent years, advances in artificial intelligence (AI) have improved the accuracy of image classification. This image classification is, for example, classifying from some image (medium) whether the image or a specific object in the image is a pigeon or a swallow.

Conventionally, in image classification, a technique has been proposed for improving the accuracy of image classification by using not only the comparison of feature amounts between image data but also the results of comparison between text data attached to the image data or input by a user (see NPL 1). In this case, for example, an image of a pigeon and text data that is a sentence describing the pigeon shown in the image are used.

### CITATION LIST

### Non Patent Literature

[NPL 1] Shaping Visual Representations with Language for Few-Shot Classification

### Summary of Invention

### Technical Problem

In the related art, since the comparison of feature amounts between image data and the comparison between text data are only performed independently, there arises a problem that multimodal feature amounts cannot be extracted.

The present invention has been made in view of the above points, and an object of the present invention is to extract a multimodal feature amount in contrast with the related art.

### Solution to Problem

To solve the above problem, the invention according to claim 1 is an image processing apparatus for extracting a feature amount of image data, the image processing apparatus including: an image understanding unit that vectorizes an image pattern of the image data to extract an image feature amount; a text understanding unit that vectorizes a text pattern of attached text data attached to the image data to extract a text feature amount; and a feature amount mixing unit that generates a mixed feature amount as the feature amount by projecting the image feature amount extracted by the image understanding unit and the text feature amount extracted by the text understanding unit onto the same vector space and mixing the image feature amount and the text feature amount.

### Advantageous Effects of Invention

As described above, the present invention has the effect of being able to extract a multimodal feature amount as compared with the related art.

### BRIEF DESCRIPTION OF DRAWINGS

FIG. 1 is a schematic diagram of a communication system of the present embodiment.

FIG. 2 is a hardware configuration diagram of an image classification apparatus and a communication terminal.

FIG. 3 is a functional configuration diagram of the image classification apparatus according to the embodiment of the present invention.

FIG. 4 is a detailed functional configuration diagram of a feature extraction unit in the image classification apparatus.

FIG. 5 is a detailed functional configuration diagram of a text generation unit in the feature extraction unit.

FIG. 6 is a flowchart illustrating processing executed by the image classification apparatus in a training (learning) phase.

FIG. 7 is a flowchart illustrating detailed processing executed by the feature extraction unit.

FIG. 8 is a flowchart illustrating processing executed by the image classification apparatus in an inference phase.

FIG. 9 is a diagram illustrating experimental results.

### DESCRIPTION OF EMBODIMENTS

Embodiments of the present invention will be described below with reference to the drawings.

### System Configuration of Embodiment

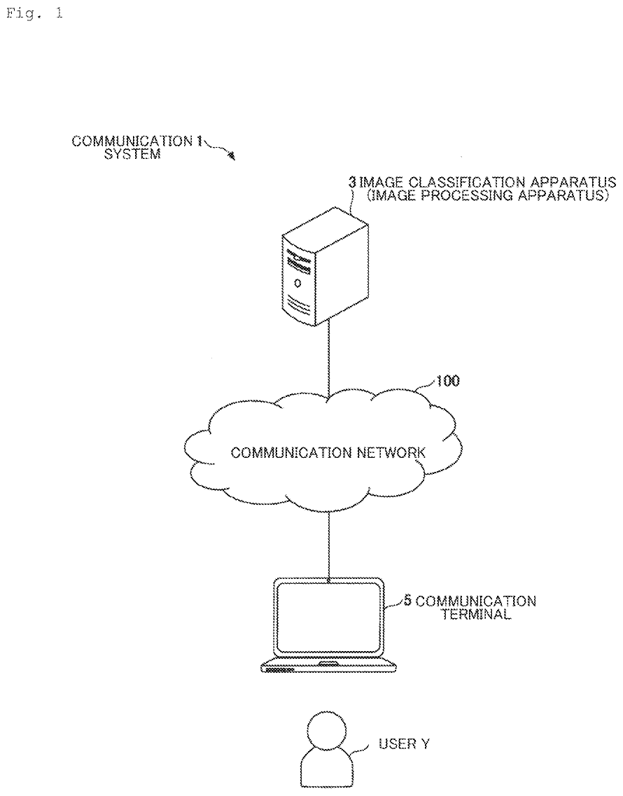

First, the outline of a configuration of a communication system 1 according to the present embodiment will be described with reference to FIG. 1. FIG. 1 is a schematic diagram of a communication system according to an embodiment of the present invention.

As illustrated in FIG. 1, a communication system 1 of the present embodiment is constructed by an image classification apparatus 3 and a communication terminal 5. The communication terminal 5 is managed and used by a user Y.

The image classification apparatus 3 and the communication terminal 5 can communicate with each other via a communication network 100 such as the Internet. The connection form of the communication network 100 may be either wireless or wired.

The image classification apparatus 3 is composed of one or more computers. When the image classification apparatus 3 is composed of a plurality of computers, it may be indicated as an “image classification apparatus” or as an “image classification system”.

The image classification apparatus 3 is an apparatus that performs image classification by artificial intelligence (AI). This image classification is, for example, classifying from some image (medium) whether the image or a specific object in the image is a pigeon or a swallow. Then, the image classification apparatus 3 outputs classification result data which is a result of image classification. As an output method, by transmitting the classification result data to the communication terminal 5, a graph or the like related to the classification result data may be displayed or printed on the communication terminal 5 side, the graph or the like may be displayed on a display connected to the image classification apparatus 3, or the graph or the like may be printed on a printer or the like connected to the image classification apparatus 3.

The communication terminal 5 is a computer, and although a notebook computer is illustrated as an example in FIG. 1, it is not limited to the node type, and may be a desktop computer. Also, the communication terminal may be a smartphone or a tablet terminal. In FIG. 1, the user Y operates the communication terminal 5.

### [Hardware Configuration Diagram of Image Classification Apparatus and Communication Terminal]

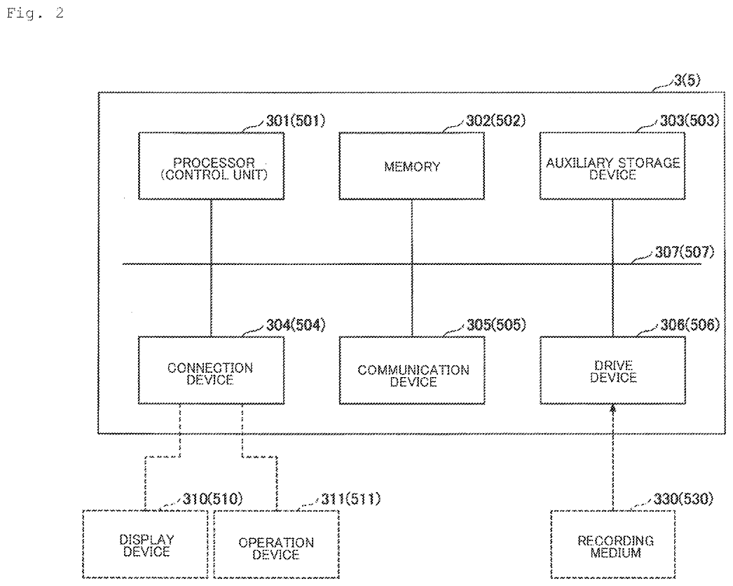

Next, a hardware configuration of the image classification apparatus 3 and the communication terminal 5 will be described with reference to FIG. 2. FIG. 2 is a hardware configuration diagram of the image classification apparatus and the communication terminal.

As illustrated in FIG. 2, the image classification apparatus 3 includes a processor 301, a memory 302, an auxiliary storage device 303, a connection device 304, a communication device 305, and a drive device 306. Each piece of hardware constituting the image classification apparatus 3 is interconnected via a bus 307.

The processor 301 serves as a control unit that controls the entire image classification apparatus 3, and includes various arithmetic devices such as a central processing unit (CPU). The processor 301 reads various programs onto the memory 302 and executes them. Note that the processor 301 may include a general-purpose computing on graphics processing units (GPGPU).

The memory 302 has main storage devices such as a read only memory (ROM) and a random access memory (RAM). The processor 301 and the memory 302 form a so-called computer, and the processor 301 executes various programs read onto the memory 302, thereby implementing various functions of the computer.

The auxiliary storage device 303 stores various programs and various types of information used when the various programs are executed by the processor 301.

The connection device 304 is a connection device that connects an external device (for example, a display device 310 and an operation device 311) and the image classification apparatus 3.

The communication device 305 is a communication device for transmitting and receiving various types of information to and from another device.

The drive device 306 is a device for setting a recording medium 330. The recording medium 330 mentioned herein includes a medium that optically, electrically or magnetically records information, such as a compact disc read-only memory (CD-ROM), a flexible disk, or a magneto-optical disk. The recording medium 330 may also include a semiconductor memory that electrically records information, such as a read only memory (ROM) and a flash memory.

Various programs to be installed in the auxiliary storage device 303 are installed, for example, by setting the distributed recording medium 330 in the drive device 306 and reading the various programs recorded in the recording medium 330 by the drive device 306. Alternatively, various programs installed in the auxiliary storage device 303 may be installed by being downloaded from the network via the communication device 305.

Although FIG. 2 illustrates the hardware configuration of the communication terminal 5, since the configuration is the same except that the reference numerals are changed from those in the 300s to those in the 500s, the description thereof will be omitted.

### [Functional Configuration of Image Classification Apparatus]

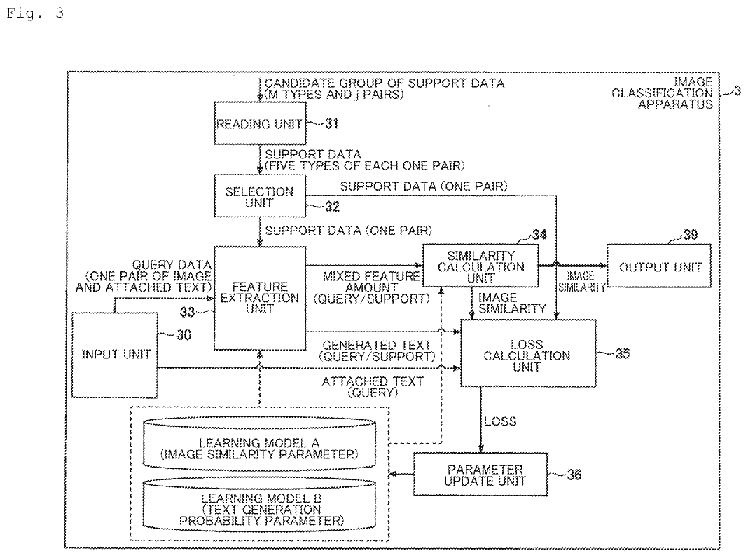

Next, a functional configuration of the image classification apparatus will be described with reference to FIG. 3. FIG. 3 is a functional configuration diagram of the image classification apparatus according to the embodiment of the present invention.

In FIG. 3, the image classification apparatus 3 includes an input unit 30, a reading unit 31, a selection unit 32, a feature extraction unit 33, a similarity calculation unit 34, a loss calculation unit 35, a parameter update unit 36, and an output unit 39. These respective units are functions implemented by instructions from the processor 301 of FIG. 2 based on programs.

Further, learning models A and B are stored in the memory 302 or the auxiliary storage device 303 of FIG. 2. The learning model A is constructed by a large number of image similarity parameters to be described later. Also, the learning model B is constructed by a large number of text generation probability parameters to be described later. Further, the memory 302 and the auxiliary storage device 303 of FIG. 2 store a large number of pieces of image data which are candidate groups for support data as training data. Text data indicating the content of an image is attached to each of the large number of image data. That is, one pair of pieces of support data is constituted by the image data and the attached text data, and a large number of pairs of pieces of support data are stored in the memory 302 or the auxiliary storage device 303 of FIG. 2. For example, one pair of pieces of support data includes image data of a pigeon and text data that is a sentence describing the pigeon shown in the image attached to the image data. Hereinafter, the text data attached to the image data will be referred to as “attached text data”. Note that “attached” includes a case where text data is added to image data, and a case where the text data and the image data are separately input or output and related to each other. Text data attached to image data may be generated on the basis of the image data by the image classification apparatus 3 (generated text data) and added to the image data.

The input unit 30 inputs image data being query data as classification object (evaluation object) data for training or inference. For example, the input unit 30 inputs query data transmitted from the communication terminal 5 to the image classification apparatus 3 by the user Y to the image classification apparatus. Attached text data is attached to the image data which is the query data. That is, one pair of pieces of query data is composed of the image data and the attached text data. In the case of the training phase, the attached text data is always attached, but in the case of the inference phase, the attached text data may not be attached. As a method for attaching the attached text data, there are cases where it is captioned in the image data or cases where it is manually input by the user Y. In many machine learning models, humans cannot intervene in the inference of image classification, but by enabling the user Y to input text data, the user Y can intervene in inference of image classification.

The reading unit 31 reads a candidate group (M types and j pairs for each type) of support data for comparison with the query data from the memory 302 or the auxiliary storage device 303 of FIG. 2. For example, M is 100 and j is 60. In this case, a total of 6000 pairs will be read. In addition, “M is 100 and j is 60” is an example, and M may be more than 100 or less than 100, and j may be more than 60 or less than 60.

The selection unit 32 randomly selects N types of each k pairs of pieces of support data for comparison with the query data from the candidate group of support data. Here, the following description will be made on the assumption that, for example, N, which is five, types of support data and k, which is one, pairs of each (five pairs in total) are randomly selected. Although the method of selecting one pair of pieces of support data in the five types is generally performed, the selection unit 32 does not necessarily need to select each one pair of pieces of support data in the five types. For example, each two pairs in 10 types (20 pairs in total) may be selected. In addition to the image data and the attached text data, information indicating the type of a subject (also referred to as a “class”) shown in the image of the image data is added to the support data for training. For example, when the image is an image of a bird, the class indicates the type of bird such as “pigeon”, “hawk”, “swallow”.

The feature extraction unit 33 extracts an image feature amount from image data in one pair, and further extracts a text feature amount from text data in the same pair. Further, the feature extraction unit 33 generates a mixed feature amount by mixing the image feature amount and the text feature amount. The feature extraction unit 33 also generates text data from the image feature amount. Thereafter, the text data generated from the image feature amount will be referred to as “generated text data”. That is, the generated text data is image-derived text data, and is different in type from text-derived attached text data.

### <Feature Extraction Unit>

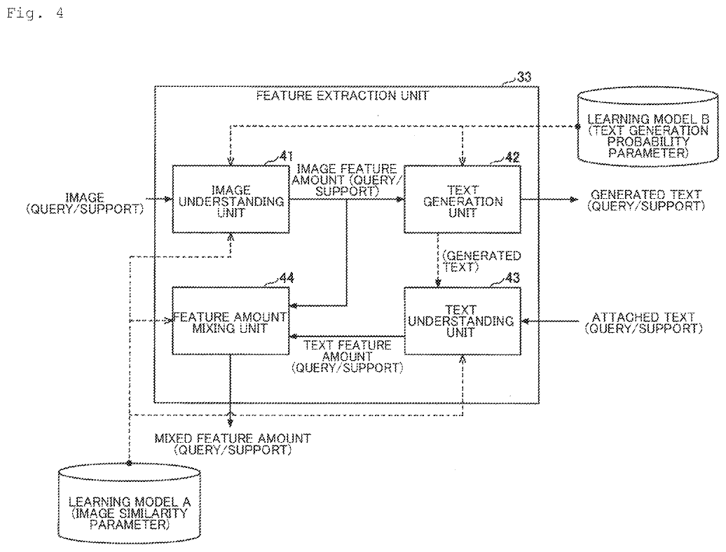

Here, the feature extraction unit in the image classification apparatus will be described in detail with reference to FIG. 4. FIG. 4 is a detailed functional configuration diagram of the feature extraction unit in the image classification apparatus.

As illustrated in FIG. 4, the feature extraction unit 33 includes an image understanding unit 41, a text generation unit 42, a text understanding unit 43, and a feature amount mixing unit 44. Arbitrary neural networks can be used for the image understanding unit 41, the text generation unit 42, the feature amount mixing unit 44, and the similarity calculation unit 34. For example, four layers of convolutional neural network (CNN) are used for the image understanding unit 41. The text generation ability and the text understanding ability are improved by performing pre-learning of the text generation unit 42 and the text understanding unit 43.

Among them, the image understanding unit 41 acquires image data (an example of first image data) of the query data from the input unit 30, and acquires image data (an example of second image data) of one specific pair of pieces of support data in five types of one pair from the selection unit 32. Then, the image understanding unit 41 vectorizes an image pattern of the image data of the query data to extract an image feature amount for query, and vectorizes an image pattern of the image data of the support data to extract an image feature amount for support. An image feature amount is a vector, and the text generation unit 42 can use an arbitrary neural network, and a recurrent neural network (RNN) or a transformer with an image feature amount as an initial value is generally used.

The text generation unit 42 projects the image feature amount for query extracted by the image understanding unit 41 onto a vector space of text data and decodes the image feature amount for query to generate image-derived generated text data for query, projects the image feature amount for support extracted by the image understanding unit 41 onto a vector space of the text data and decodes the image feature amount for support to generate image-derived generated text data for support.

### (Text Generation Unit)

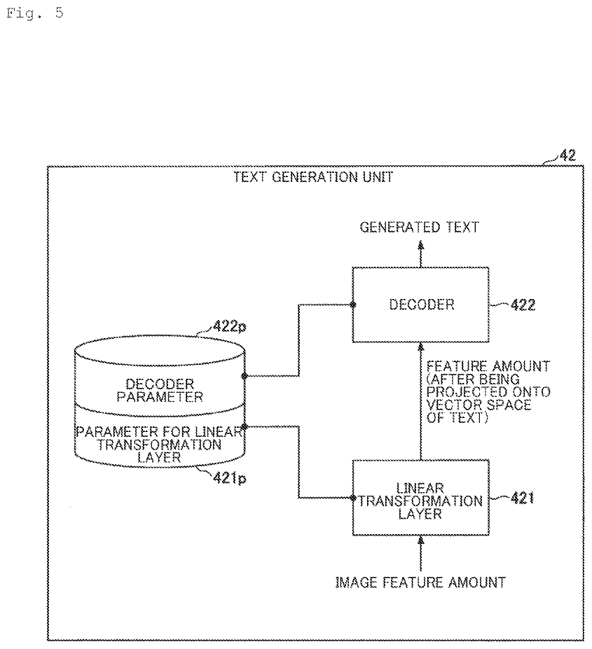

Here, the text generation unit 42 will be described in more detail with reference to FIG. 5. FIG. 5 is a detailed functional block diagram of the text generation unit. As illustrated in FIG. 5, the text generation unit 42 includes a linear transformation layer 421 and a decoder 422. Further, the linear transformation layer 421 holds a parameter 421p for a linear transformation layer, and the decoder 422 holds a decoder parameter 422p. The parameter 421p for a linear transformation layer and the decoder parameter 422p are included in the learning model B illustrated in FIG. 4.

The linear transformation layer 421 uses the parameter 421p for a linear transformation layer to project the image feature amount acquired from the image understanding unit 41 onto a vector space of the attached text data, thereby extracting an image-derived feature amount.

The decoder 422 uses the decoder parameter 422p to generate image-derived generated text data from the feature amount acquired from the linear transformation layer 421.

Here, by diverting an existing pre-trained language model for the text generation unit 42 and the text understanding unit 43, it can be regarded that pre-learning of the text generation unit 42 and the text understanding unit 43 has been performed. However, the existing language model cannot be used as it is for the text generation unit 42. This is because an existing language model having the ability to generate text has an encoder-decoder type structure.

A language model having an encoder-decoder type structure is disclosed in Reference 1, for example.

<Reference 1>Exploring the Limits of Transfer Learning with a Unified Text-to-Text Transformer

An encoder-decoder type structure is a structure in which text is first given as an input, converted into feature amounts by the encoder, the feature amounts are input to the decoder, and the decoder generates text. In the present embodiment, since the image feature amount is input to the text generation unit 62, an arbitrary neural network such as a linear transformation layer is added before the decoder instead of using the encoder of the existing language model in Reference 1. This configuration makes it possible to convert image feature amounts into feature amounts suitable for language models, input them to the decoder, and generate text.

Then, referring back to FIG. 4, the text understanding unit 43 acquires attached text data of the query data from the input unit 30, and acquires attached text data of one specific pair of pieces of support data in five types of one pair from the selection unit 32. The text understanding unit 43 vectorizes a text pattern of the attached text data of the query data to extract a text feature amount for query, and vectorizes a text pattern of the attached text data of the support data to extract a text feature amount for support.

For example, the text understanding unit 43 converts text data into vectors by an existing language model such as Bidirectional Encoder Representations from Transformers (BERT).

As described above, the attached text data is attached to the image data in the training phase, but the attached text data may not be attached to the image data in the inference phase. In such a case, the text understanding unit 43 uses (regards) the image-derived generated text data for query generated by the text generation unit 42 as attached text data to extract a feature amount of the text data derived from the image but used for the query.

Next, the feature amount mixing unit 44 generates a mixed feature amount as the feature amount for query by projecting the image feature amount for query extracted by the image understanding unit 41 and the text feature amount for query extracted by the text understanding unit 43 onto the same vector space and mixing the image feature amount for query and the text feature amount for query. Similarly, the feature amount mixing unit 44 generates a mixed feature amount as the feature amount for support by projecting the image feature amount for support extracted by the image understanding unit 41 and the text feature amount for support extracted by the text understanding unit 43 onto the same vector space and mixing the image feature amount for support and the text feature amount for support. In the process of mixing the image feature amount and the text feature amount, there are cases where one feature amount is projected to the vector space of the other feature amount, and where one feature amount is projected to a third vector space different from each other.

For example, the feature amount mixing unit 44 can reflect both the image feature amount and the text feature amount in the similarity calculation. The feature amount mixing unit 44 can use an arbitrary neural network for receiving both the image feature amount and the text feature amount as inputs.

Here, the feature amount mixing unit 44 will be described in more detail.

The following model is used as the feature amount mixing unit 44. The image feature amount is defined as ximage, and the text feature amount output by the text understanding unit 43 is defined as x_{Lang}. Multilayer perceptron (MLP) is used as a three-layer neural network. Linear is used as a two-dimensional linear transformation layer. [;] is used as an operation for connecting vectors vertically. At this time, a vector h output by the feature amount mixing unit 44 is represented by (Formula 1), (Formula 2), and (Formula 3) as follows.

$$\begin{matrix}[ Math . 1 ] & \\ {z}_{lang} = MLP ( {x}_{lang} ) & ( Formula 1 )\end{matrix}$$

$$\begin{matrix}[ Math . 2 ] & \\ {λ}_{image} , {λ}_{lang} = softmax ( Linear ( [ {x}_{image} ; {z}_{lang} ] ) ) & ( Formula 2 )\end{matrix}$$

$$\begin{matrix}[ Math . 3 ] & \\ h = {λ}_{image} {x}_{image} + {λ}_{lang} {z}_{lang} & ( Formula 3 )\end{matrix}$$

First, the feature amount mixing unit 44 projects the text feature amount output from the BERT by MLP onto the same space as the image feature amount (z_{Lang}) using (Formula 1).

Next, the feature amount mixing unit 44 dynamically determines the degree of importance of the image feature amount and the text feature amount by Δ_{image} and Δ_{Lang} using (Formula 2). Δ_{image} and Δ_{Lang} are guaranteed to be non-negative numbers summing to 1 by the softmax operation. For example, when the original resolution of the image data is low (when the target object is extremely small and blurred in the image), Δ_{image} and Δ_{Lang} are dynamically determined to increase the degree of the attached text data attached to the image data to be given to the classification result. Further, by adjusting the Δ_{image} and the Δ_{Lang} in the range of 0 to 1 by the user himself/herself, the degree of reflection of the text input by the user in the classification result can be manually changed. Linear is an operation for multiplying a weight matrix from the left and adding a bias vector. The weight matrix and the bias vector during the Linear operation are included in an image similarity parameter of the learning model A and a text generation probability parameter of the learning model B.

Finally, the feature amount mixing unit 44 determines the feature amount to be output by a weighted sum according to the degree of importance using (Formula 3).

Also, as illustrated in FIG. 4, the image similarity parameter of the learning model A is used when the image understanding unit 41, the text understanding unit 43, and the feature amount mixing unit 44 execute each process. The text generation probability parameter of the learning model B is used when the image understanding unit 41 and the text generation unit 42 execute each process. However, in the case of the inference phase, when the attached text data is attached to the image data, the text generation probability parameter of the learning model B is not used.

In the case of the training phase, even when attached text data is attached to the image data, the text generation probability parameter of the learning model B is used, and the updating by training (learning) is also performed. This is to enable the text generation unit 42 to generate the generated text data even when the attached text data is not attached to the image data in the case of the inference phase. This is also because training (learning) of the learning model B has a positive effect that the understanding ability of the image understanding unit 41 using the text generation probability parameter is improved.

Then, referring back to FIG. 3, the similarity calculation unit 34 compares a mixed feature amount for query with a mixed feature amount for support to calculate the image similarity. In the case of the inference phase, the image similarity is output to the output unit 39 and used as classification result data for the image classification. On the other hand, in the case of the training phase, the image similarity is output to the loss calculation unit 35.

For example, the similarity calculation unit 34 is a bilinear layer. Here, N-way k-shot image classification is considered. The similarity calculation unit 34 first gives k support feature amounts (vectors) for each class. A vector obtained by averaging these values is used as a class feature amount. A matrix in which N class feature amounts (vectors) are arranged is defined as X. The feature amount of the query data is defined as y, and the learnable parameter is defined as W. At this time, the classification score for each class of query data is expressed as follows.

X^{T}Wy∈R^{N} [Math. 4]

Each component of the vector indicates the likelihood that the query data belongs to each class.

The loss calculation unit 35 calculates a loss function value from the image similarity. The loss calculation unit 35 calculates a loss function value from generated text data of the query data/support data, a generation probability distribution of the query data/support data, and attached text data of the query data/support data.

For example, as the loss function calculated by the loss calculation unit 35, the classification score of the similarity calculation unit 34 and any loss related to text generation can be used. Cross-Entropy Loss and negative log-likelihood function are typically used.

The parameter update unit 36 updates the image similarity parameter of the learning model A of the neural network constituting the feature extraction unit 33 and the similarity calculation unit 34 on the basis of the loss function value calculated by the loss calculation unit 35 from the image similarity calculated by the similarity calculation unit 34. In this case, the loss calculation unit 35 performs learning so that the similarity between the image data of the support data and the image data of the query data is reduced, and further, the similarity with the incorrect image is increased.

Further, the parameter update unit 36 updates the text generation probability parameter of the learning model B of the neural network constituting the feature extraction unit 33 and the similarity calculation unit 34 on the basis of the loss function value calculated by the loss calculation unit 35. In this case, the loss calculation unit 35 performs learning so that the probability that the generated text data is similar to the attached text data becomes high.

For example, the parameter update unit 56 calculates a gradient of the loss on the basis of the loss calculated by the loss calculation unit 35, and updates the parameter.

### [Processing or Operation of Embodiment]

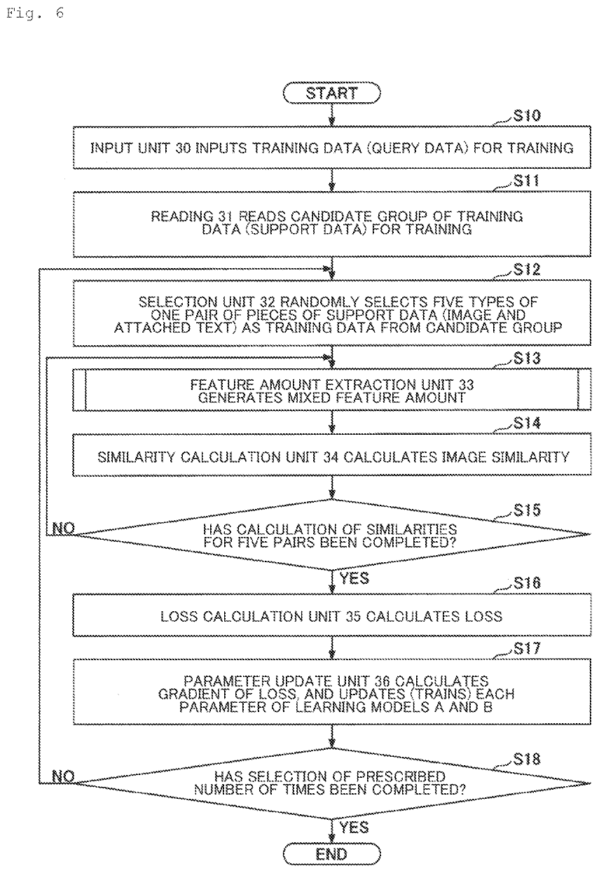

Next, the processing or operation of the present embodiment will be described in detail with reference to FIGS. 6 to 8. Note that a training (learning) phase and an inference phase will be described separately.

### <Training Phase>

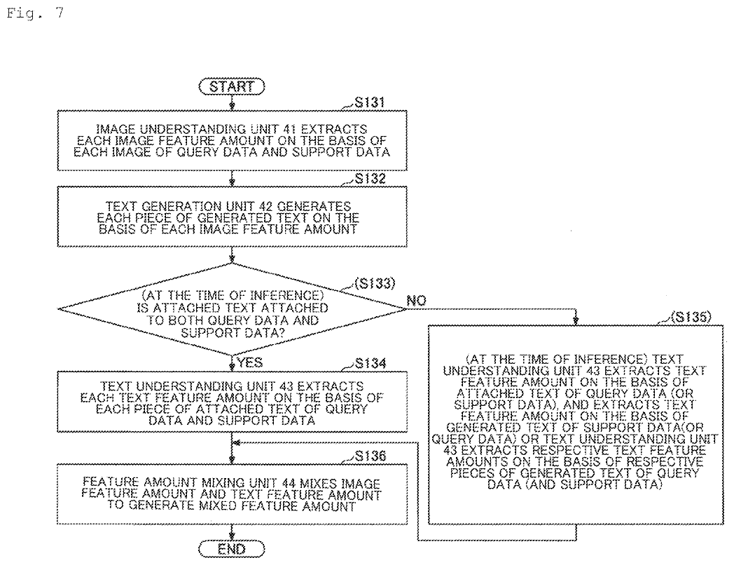

First, the training phase will be described with reference to FIGS. 6 and 7. FIG. 6 is a flowchart illustrating processing executed by the image classification apparatus in the training (learning) phase.

First, the input unit 30 inputs training data (query data) for training (S10). The reading unit 31 reads a candidate group of training data (support data) for training (S11). The selection unit 32 randomly selects five types of one pair of pieces of support data (image data and attached text data) as training data from the candidate group (S12). The selection unit 32 also selects an arbitrary number of pairs from the same five types as query data. At this time, for each piece of selected query data, the selection unit 32 defines the same type of support data as a correct answer for the query data, and defines different types of support data as an incorrect answer for the query data, thereby adding data defining the correct answer or the incorrect answer to the support data. For example, when the query data indicates “pigeon”, of the five types of support data, the support data indicating “pigeon” is defined as the correct answer, and the support data indicating the other types (classes) is defined as the incorrect answer. The definition of the correct answer or the incorrect answer may be performed by the reading unit 31.

Next, the feature extraction unit 33 generates a mixed feature amount for query on the basis of the query data acquired from the input unit 30, and generates a mixed feature amount for support on the basis of a predetermined one piece of support data out of five types of one pair of pieces of support data (five pairs in total) selected by the selection unit 32 (S13). At this time, the feature extraction unit 33 receives set data (query data, support data, and definition data of correct or incorrect answers) in which the correct or incorrect answers are defined, calculates a mixed feature amount of the query data and the support data included in the set data, and outputs the mixed feature amount to the similarity calculation unit. At this time, when the number k of pairs of pieces of support data is two or more, a vector obtained by averaging the image feature amounts of the data of each pair of images only needs to be used as the image feature amount of the support data.

Here, detailed processing executed by the feature extraction unit will be described with reference to FIG. 7. FIG. 7 is a flowchart illustrating detailed processing executed by the feature extraction unit.

As illustrated in FIG. 7, the image understanding unit 41 extracts each image feature amount (an image feature amount for query and an image feature amount for support) on the basis of each piece of image data of the query data and the support data (S131). The text generation unit 42 generates each piece of generated text data on the basis of each image feature amount (S132). In the training phase, steps S133 and S135, which will be described later, are not executed, and subsequently, the text understanding unit 43 extracts respective text feature amounts (a text feature amount for query and a text feature amount for text) on the basis of respective pieces of attached text data of the query data and the support data (S134). The feature amount mixing unit 44 mixes the image feature amount for query and the text feature amount for query to generate a mixed feature amount for query, and mixes the image feature amount for support and the text feature amount for support to generate a mixed feature amount for support (S136).

Then, referring back to FIG. 6, the similarity calculation unit 34 compares a mixed feature amount for query (an example of a first mixed feature amount) with a mixed feature amount for support (an example of a second mixed feature amount) to calculate the image similarity (S14). At this time, the similarity calculation unit 34 calculates the similarity of each pair of pieces of the query data and the support data included in the set data, and transfers the similarity to the loss calculation unit.

The feature extraction unit 33 determines whether or not calculation of the similarities of all five pairs out of the five types of one pair of pieces of support data (five pairs in total) selected by the selection unit 32 has been completed (S15). Then, when the feature extraction unit 33 determines that the calculation of the similarities for all the five pairs of pieces of support data has not been completed (S15; NO), the process returns to step S13, and step S13 and the subsequent steps are performed on the support data in which the calculation of the similarities has not been completed. As for the query data acquired from the input unit 30, since the mixed feature amount has already been generated, the re-processing of step S13 and the subsequent steps is not performed.

On the other hand, in step S15, when the feature extraction unit 33 determines that the calculation of the similarities for all the five pairs has been completed (S15; YES), the loss calculation unit 35 calculates the loss (S16). At this time, the loss calculation unit 35 calculates the loss on the basis of each similarity of a pair of query data and support data included in each piece of set data and definition data of correct or incorrect answers of each pair of pieces of support data with respect to the query data. The similarity includes a similarity between images and a similarity between attached texts.

### <Supplement A>

In the training phase in which the attached text data in the training data can be used, the attached text data in the training data is input to the text understanding unit 43. However, in the inference phase, since there is a possibility that the generated text data generated by the text generation unit 42 is input, a divergence occurs between the training phase and the inference phase. Therefore, in the present embodiment, learning is performed using not only cross-entropy loss L_{class,gold} calculated from the image feature amount and the attached text data but also cross-entropy loss L_{class,gen} calculated from the image feature amount and the generated text data generated by the text generation unit 42. By this processing, the divergence between the training phase and the inference phase can be suppressed.

### <Supplement B>

Also, by using a loss L_{cntr} of contrastive learning shown in (Formula 4), it is possible for the model to capture minute differences of the text data and acquire feature amounts.

$$\begin{matrix}[ Math . 4 ] & \\ {L}_{cntr} = \frac{1}{2 N} {\sum }_{c} log \frac{exp [ cos ( {v}_{gold}^{c} {}^{T} {v}_{gen}^{c} ) / τ ]}{{\sum }_{{c}^{′}} exp [ cos ( {v}_{gold}^{c} {}^{T} {v}_{gen}^{{c}^{′}} ) / τ ]} + \frac{1}{2 N} {\sum }_{{c}^{′}} log \frac{exp [ cos ( {v}_{gold}^{{c}^{′}} {}^{T} {v}_{gen}^{{c}^{′}} ) / τ ]}{{\sum }_{c} exp [ cos ( {v}_{gold}^{c} {}^{T} {v}_{gen}^{{c}^{′}} ) / τ ]} & ( Formula 4 )\end{matrix}$$

Here,

v_{gold}^{c} [Math. 6]

is a vector obtained by averaging the vector h created by the feature amount mixing unit 44 by inputting the attached text data in the training data with respect to the k supporting feature amounts of the class c by the similarity calculation unit 34.

v_{gold}^{c} [Math. 7]

is a vector calculated by the loss calculation unit 35 on the basis of the input of generated text data similarly generated by the text generation unit 42. Note that contrastive learning is learning that distinguishes between a positive example and a negative example such that the input and the positive example approach each other and the input and the negative example move away from each other. In this case, the parameter update unit 36 uses L_{cntr} to update the text generation probability parameter such that the respective text feature amounts vcgold and vcgen of “attached text data in training data” and “generated text data generated by the text generation unit” attached to images of the same class approach each other.

v_{gold}^{c},v_{gen}^{c} [Math. 8]

In addition, the parameter update unit 36 uses L_{cntr} to update the text generation probability parameter such that the feature amounts vcgold and vcgen of “attached text data in training data” and “generated text data generated by the text generation unit” attached to images of different classes move away from each other.

V_{gold}^{c},v_{gen}^{c} [Math. 9]

By performing contrastive learning in this way, there is an effect that learning can proceed such that the text understanding unit 43 outputs a feature amount that captures minute differences between both text data.

As described above, the loss function L is a value obtained by summing the above four L values according to (Formula 5).

$$\begin{matrix}[ Math . 10 ] & \\ L = {L}_{class , gold} + {L}_{class , gen} + {λ}_{text} {L}_{text} + {λ}_{cntr} {L}_{cntr} & ( Formula 5 )\end{matrix}$$

Note that,

τ,λₜₑₓₜ,λ_{cntr} [Math. 11]

are hyperparameters.

Next, the parameter update unit 36 calculates the gradient of the loss, and updates (trains) the image similarity parameter of the learning model A and the text generation probability parameter of the learning model B (S17). At this time, the parameter update unit 36 updates the parameters to minimize the loss.

Next, the selection unit 32 determines whether or not selection of a prescribed number of times (for example, 20 times) has been completed (S18). For example, when the selection unit 32 selects 20 times as a prescribed number of times, since five pairs of pieces of support data are selected by one selection, 100 pairs of pieces of support data are selected in total. However, since the selection unit 32 randomly selects five types of one pair of pieces of support data (five pairs in total) from the candidate group, the same support data may be selected a plurality of times.

Then, in step S18, when the selection unit 32 determines that the selection of the prescribed number of times has not been completed (S18; NO), the process returns to step S12, and the selection unit 32 newly selects five types of one pair of pieces of support data (five pairs in total) from the candidate group at random, and then processes after step S13 are performed.

On the other hand, in step S18, when the selection unit 32 determines that the selection of the prescribed number of times has been completed (S18; YES), the processing of the training phase illustrated in FIG. 6 ends.

### <Inference Phase>

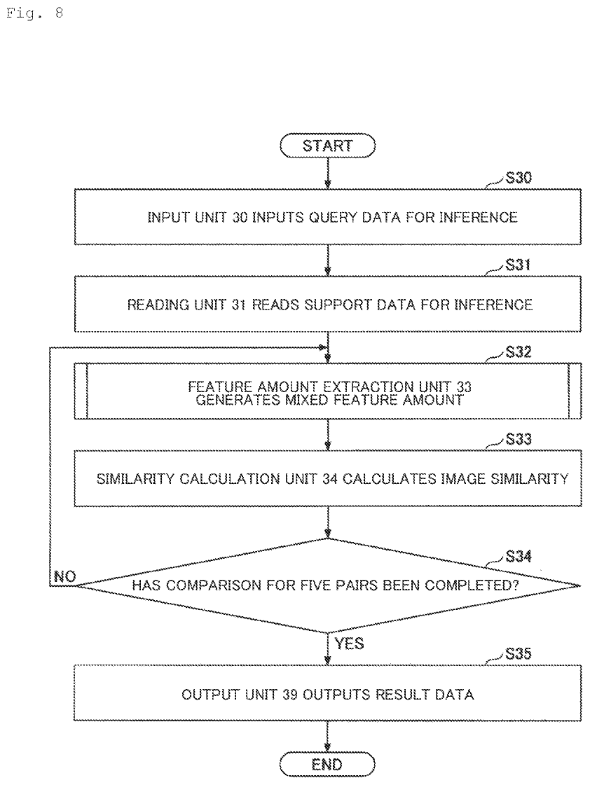

Next, the training phase will be described with reference to FIGS. 7 and 8. FIG. 8 is a flowchart illustrating processing executed by the image classification apparatus in the inference phase.

First, the input unit 30 inputs query data, which is classification object data for inference (S30). The reading unit 31 reads support data for inference (S31).

Next, the feature extraction unit 33 generates a mixed feature amount for query on the basis of the query data, which is the classification object data acquired from the input unit 30, and generates a mixed feature amount for support on the basis of a predetermined one piece of support data out of five types of one pair of pieces of support data (five pairs in total) selected by the selection unit 32 (S32). Here, detailed processing executed by the feature extraction unit will be described with reference to FIG. 7. FIG. 7 is a flowchart illustrating detailed processing executed by the feature extraction unit.

As illustrated in FIG. 7, the image understanding unit 41 extracts each image feature amount (an image feature amount for query and an image feature amount for support) on the basis of each piece of image data of the query data and the support data (S131). The text generation unit 42 generates each piece of generated text data on the basis of each image feature amount (S132). In the inference phase, steps S133 and S135, which will be described later, are executed.

### <Supplement C>

In the inference phase, generated text data is generated using beam-search. Therefore, for example, assuming that the beam width is 10, the top ten tokens at each of times can be used as generation candidates. However, beam-search is computationally heavy and cannot be used in the training phase. Therefore, in order to suppress the divergence between the training phase and the inference phase, the text generation unit 42 performs a process of “language generation”.

The process of “language generation” is a process of generating generated text data by combining the greedy method and random sampling in the training phase. In the greedy method, the text generation unit 42 selects the highest token at each of times and generates generated text data. During random sampling, the text generation unit 42 selects tokens by sampling from a predetermined number of high-order (for example, top 20) tokens at each of times, thereby generating generated text data. Also, during the test, when the attached text data is not given from the input unit 30, the text generation unit 42 transfers the generated text data to the text understanding unit 43. At this time, the text generation unit 42 performs a beam search with a length penalty of 0.5 and a beam width of 5, generates generated text data that maximizes the classification score for each class of the query data, and transfers the generated text data to the text understanding unit 43.

Therefore, the text understanding unit 43 determines whether or not the attached text data is included in both the query data and the support data, that is, whether or not the attached text data is attached to both the image data of the query data and the image data of the support data (S133). When the text understanding unit 43 determines that the attached text data is included in both the query data and the support data, that is, the attached text data is attached to both the image data of the query data and the image data of the support data (S133; YES), the text understanding unit 43 extracts respective text feature amounts (a text feature amount for query and a text feature amount for text) on the basis of respective pieces of attached text data of the query data and the support data (S134).

On the other hand, in step S133, when the text understanding unit 43 determines that the attached text data is not included in both the query data and the support data, that is, the attached text data is not attached to both the image data of the query data and the image data of the support data (S133; NO), the text understanding unit 43 performs the following processing.

That is, in the above case (S133; NO), when the support data does not include the attached data, the text understanding unit 43 extracts a text feature amount on the basis of the attached text of the query data, and extracts a text feature amount on the basis of the generated text of the support data (S135). In a similar case (S133; NO), when the query data does not include the attached data, the text understanding unit 43 extracts a text feature amount on the basis of the attached text of the support data, and extracts a text feature amount on the basis of the generated text of the query data (S135). In a similar case (S133; NO), when both the query data and the support data do not include attached text data, the text understanding unit 43 extracts respective text feature amounts on the basis of respective pieces of generated text of the query data and the support data (S135).

### <Supplement D>

When the text generation unit 42 learns only with Lₜₑₓₜ calculated by teacher-forcing and cross-entropy loss as the loss of generation of generated text data, the purpose of learning is to “reproduce the attached text data in the training data”, and “generating generated text data that contributes to image classification” is not taken into consideration. This is because the gradient graph is broken by the discrete processing of the text generation unit 42. In other words, this is because the gradients obtained from the losses (L_{class,gold} and L_{class,gen}) obtained by image classification are not propagated to the text generation unit 42 by the error backpropagation method. In order to improve this, the text understanding unit 43 performed the following processing.

That is, in the present embodiment, the text understanding unit 43 first maps (projects) the x_{image} onto the same vector space as the text feature amount by (Formula 6).

$$\begin{matrix}[ Math . 12 ] & \\ {f}_{I 2 T} ( {x}_{image} ) = Linear ( LayerNorm ( {x}_{image} ) ) & ( Formula 6 )\end{matrix}$$

Here, LayerNorm indicates Layer Normalization (Reference 2).
<Reference 2>Jimmy Lei Ba, Jamie Ryan Kiros, and Geoffrey E Hinton. Layer normalization. arXiv preprint arXiv: 1607.06450, 2016.

The text understanding unit 43 transfers the obtained expression to the text generation unit 42 as a sequence of length l. Then, the text generation unit 42 autoregressively generates the j-th token tj according to the probability pj shown in (Formula 7) below. That is, the probability pj indicates a probability of a predetermined-order (j-th) token tj related to the generated text data generated by the text generation unit 42 being correct (likelihood).

$$\begin{matrix}[ Math . 13 ] & \\ {p}_{j} = Pr ( {t}_{j} ; {f}_{I 2 T} ( {x}_{image} ) , {t}_{0 : j - 1} ) & ( Formula 7 )\end{matrix}$$

In order to extract the text feature amount X_{Lang} represented by (Formula 8), the text understanding unit 43 also performs weighted pooling using a probability pj that indicates a likelihood of the predetermined-order (j-th) token tj related to the generated text data.

Here, the sequence of hidden states in the final layer of the text understanding unit 43 is assumed to be H_{BERT}. When the token is a stop word, wj=0; otherwise, wj=1. Also, when attached text data is input by the input unit 30 instead of the text generation unit 42, pj=1 for all tokens.

$$\begin{matrix}[ Math . 14 ] & \\ {x}_{lang} = \frac{1}{\sum {p}_{j} {w}_{j}} \sum {p}_{j} {w}_{j} {h}_{BERT , j} & ( Formula 8 )\end{matrix}$$

In this way, by employing the text feature amount x_{Lang} that can be defined from (Formula 8), the gradient of the loss obtained from the image classification can be propagated to the text generation unit 42 using the probability pj.

Then, after step S134 or S135, the feature amount mixing unit 44 mixes the image feature amount for query and the text feature amount for query to generate a mixed feature amount for query, and mixes the image feature amount for support and the text feature amount for support to generate a mixed feature amount for support (S136).

Then, referring back to FIG. 8, the similarity calculation unit 34 compares a mixed feature amount for query (an example of a first mixed feature amount) with a mixed feature amount for support (an example of a second mixed feature amount) to calculate the image similarity (S33).

Next, the feature extraction unit 33 determines whether or not comparison of all five pairs of pieces of support data out of the five types of one pair of pieces of support data (five pairs in total) selected by the selection unit 32 has been completed (S34). Then, when the feature extraction unit 33 determines that the comparison for all the five pairs of pieces of support data has not been completed (S35; NO), the process returns to step S32, and step S32 and the subsequent steps are performed on the support data in which the comparison of the five types of one pair of pieces of support data (five pairs in total) has not been completed. As for the query data, which is the classification object data acquired from the input unit 30, since the mixed feature amount has already been generated, the re-processing of step S32 and the subsequent steps is not performed.

On the other hand, in step S34, when the feature extraction unit 33 determines that the comparison of all the five pairs of pieces of support data has been completed (S34; YES), the output unit 39 outputs classification result data indicating the classification results on the basis of the comparison results thus far (S35). The classification result data indicates, for example, that the image associated with the classification object data is an image of a pigeon, and has a 90% possibility of being an image of a pigeon, a 10% possibility of being an image of another bird, and the like.

### [Experimental Result]

Then, experimental settings and experimental results will be described.

### <Experiment Settings>

The data set Caltech-UCSD Birds (CUB) (References 3 and 4) was used as a 5-way 1-shot classification problem. This data has 200 bird breeds as classes, and there are 40 to 60 images for each breed. Of the images for 200 breeds, 100 breeds are for training, 50 breeds are for development, and 50 breeds are for testing.

<Reference 3>CatherineWah, Steve Branson, PeterWelinder, Pietro Perona, and Serge Belongie. The caltech-ucsd birds-200-2011 dataset. 2011.
<Reference 4>Scott Reed, Zeynep Akata, Honglak Lee, and Bernt Schiele. Learning deep representations of fine-grained visual descriptions. In CVPR, pp. 49-58, 2016.

### <Experimental Results>

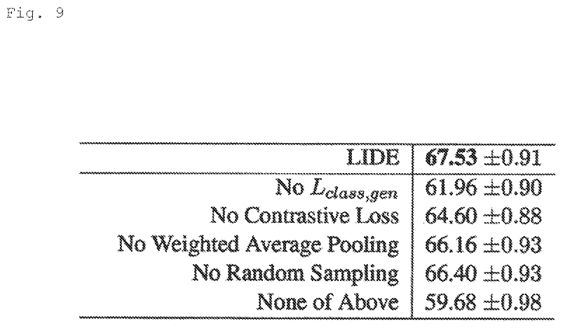

FIG. 9 is a diagram illustrating experimental results. In FIG. 9, the result of executing all the proposed methods according to the present embodiment is the value of LIDE in the first line of the first row. From there, the experimental results when the above <Supplement A>, <Supplement B>, <Supplement C>, and <Supplement D>are not performed, respectively, are shown in the first line of the second row, the second line of the second row, the fourth line of the third row, and the third line of the third row. Also, the experimental results when all of <Supplement A>, <Supplement B>, <Supplement C>, and <Supplement D>are not performed are shown in the fifth line of the second row. Thus, it was confirmed that all the four elements of the proposed method of <Supplement A>, <Supplement B>, <Supplement C>, and <Supplement D>contribute to performance improvement.

### [Main Effects of Embodiment]

As described above, according to the present embodiment, the image classification apparatus 3 generates a mixed feature amount by mixing the image feature amount of the image data with the text feature amount of the attached text data attached to the image data. Thus, as a feature extraction apparatus, the image classification apparatus 3 has the effect of being able to extract a multimodal feature amount as compared with the case of simply comparing feature amounts between image data and comparing text data with each other. Further, the image classification apparatus 3 extracts the feature amount related to the image data with higher accuracy, thereby achieving the effect of being able to perform image classification with higher accuracy.

Moreover, according to the present embodiment, the image can be accurately classified by the following processing, thereby achieving the effect that the user can intervene in the classification result by the input of attached text data in the inference phase.

According to <Supplement A>, when text data is used to supplement information in a small number of cases image classification task, the loss function of image classification is used in combination to suppress the divergence regarding the text data that can be used in the training phase and the inference phase.

Further, according to <Supplement B>, the learning of the text understanding unit 43 progresses to output feature amounts that capture minute differences in text data through contrastive learning.

Furthermore, according to <Supplement C>, the divergence between the text generation methods in the training phase and the inference phase is suppressed by generating generated text data by random sampling.

Further, according to <Supplement D>, the text generation unit 42 performs learning considering the performance improvement of image classification by pooling using the text generation score (generated score for each token).

### [Overall Supplement]

The present invention is not limited to the above-described embodiment, and may be configured or processed (operations) as described below.

The image classification apparatus 3 can be implemented by a computer and a program, and the program can be recorded in a (non-transitory) recording medium or provided via the communication network 100.

In the above embodiment, the image classification apparatus 3 is illustrated, but when the feature extraction unit 33 is specialized, it can be expressed as a feature extraction apparatus. Further, both the image classification apparatus 3 and the feature extraction apparatus can be expressed as image processing apparatuses.

In addition to the above embodiments, arbitrary processing used in neural network learning can be added to the above embodiments. For example, the number of data can be inflated by performing rule-based paraphrasing of input attached text data. As an example of paraphrasing, there is a paraphrasing of “This bird is large” by paraphrasing “big” in “This bird is big” to “large”.

### [Supplementary Notes]

The above embodiments can also be represented as the following inventions.

### [Supplementary Note 1]

An image processing apparatus for extracting a feature amount of image data, the image processing apparatus executing: an image understanding step of vectorizing an image pattern of the image data to extract an image feature amount;
a text understanding step of vectorizing a text pattern of attached text data attached to the image data to extract a text feature amount; and
a feature amount mixing step of generating a mixed feature amount as the feature amount by projecting the image feature amount extracted in the image understanding step and the text feature amount extracted in the text understanding step onto the same vector space and mixing the image feature amount and the text feature amount.

### [Supplementary Note 2]

The image processing apparatus according to Supplementary Note 1,
in which the image understanding step, the text understanding step, and the feature amount mixing step are each implemented by a neural network, and
in the image understanding step, the text understanding step, and the feature amount mixing step, processing is performed on the basis of model parameters of the neural network.

### [Supplementary Note 3]

The image processing apparatus according to Supplementary Note 2,
in which the processor executes:
a similarity calculation step of calculating an image similarity between a first mixed feature amount related to first image data generated in the feature amount mixing step and a second mixed feature amount related to second image data generated in the feature amount mixing step; and
a parameter update step of updating an image similarity parameter included in the model parameters on the basis of the image similarity calculated in the similarity calculation step.

### [Supplementary Note 4]

The image processing apparatus according to Supplementary Note 2,
in which the processor executes:
a text generation step of generating generated text data by projecting the image feature amount extracted in the image understanding step onto a vector space of the attached text data; and
a parameter update step of updating a text generation probability parameter included in the model parameters on the basis of the attached text data and the generated text data generated in the text generation step.

### [Supplementary Note 5]

The image processing apparatus according to Supplementary Note 1,
in which the processor executes:
a text generation step of generating generated text data by projecting the image feature amount extracted in the image understanding step onto a vector space of the attached text data; and
when the attached text data is not attached to the image data, the text understanding step includes a process of extracting the text feature amount by using the generated text data generated in the text generation step as the attached text data.

### [Supplementary Note 6]

The image processing apparatus according to Supplementary Note 4, in which the parameter update step includes a process of updating the text generation probability parameter on the basis of a loss based on the image feature amount and the attached text data and a loss based on the image feature amount and the generated text data.

### [Supplementary Note 7]

The image processing apparatus according to Supplementary Note 4, in which the parameter update step includes a process of updating the text generation probability parameter such that a text feature amount of the attached text data and a text feature amount of the generated text data for image data of the same class approach each other, and updates the text generation probability parameter such that a text feature amount of the attached text data and a text feature amount of the generated text data for image data of different classes move away from each other.

### [Supplementary Note 8]

The image processing apparatus according to Supplementary Note 4, in which the text generation step includes a process of using both generation of the generated text data by random sampling from a predetermined number of high-order tokens at each of times and generation of the generated text data at a normal time.

### [Supplementary Note 9]

The image processing apparatus according to Supplementary Note 4, in which the text understanding step includes a process of extracting the text feature amount by performing weighted pooling using a probability that indicates a likelihood of a predetermined-order token related to the generated text data.

### [Supplementary Note 10]

An image processing method executed by an image processing apparatus for extracting a feature amount of image data, the image processing method including:
by the image processing apparatus,
an image understanding step of vectorizing an image pattern of the image data to extract an image feature amount;
a text understanding step of vectorizing a text pattern of attached text data attached to the image data to extract a text feature amount; and
a feature amount mixing step of generating a mixed feature amount as the feature amount by projecting the image feature amount extracted in the image understanding step and the text feature amount extracted in the text understanding step onto the same vector space and mixing the image feature amount and the text feature amount.

### [Supplementary Note 11]

A non-transitory recording medium recording a program that causes a computer to execute the method according to Supplementary Note 10.

### [Others]

The present patent application claims the priority based on International Patent Application PCT/JP2021/041801 filed on Nov. 12, 2021, and the entire contents of International Patent Application PCT/JP2021/041801 are incorporated herein by reference.

### REFERENCE SIGNS LIST

1 Communication system
3 Image classification apparatus (example of image processing apparatus)
5 Communication terminal
30 Input unit
31 Reading unit
32 Selection unit
33 Feature extraction unit
34 Similarity calculation unit
35 Loss calculation unit
36 Parameter update unit
39 Output unit
41 Image understanding unit
42 Text generation unit
43 Text understanding unit
44 Feature amount mixing unit
420 Decoder

1. An image processing apparatus for extracting a feature amount of image data, the image processing apparatus comprising:
an image understanding unit that vectorizes an image pattern of the image data to extract an image feature amount;
a text understanding unit that vectorizes a text pattern of attached text data attached to the image data to extract a text feature amount; and
a feature amount mixing unit that generates a mixed feature amount as the feature amount by projecting the image feature amount extracted by the image understanding unit and the text feature amount extracted by the text understanding unit onto the same vector space and mixing the image feature amount and the text feature amount.

2. The image processing apparatus according to claim 1,
wherein the image understanding unit, the text understanding unit, and the feature amount mixing unit are each configured by a neural network, and
the image understanding unit, the text understanding unit, and the feature amount mixing unit perform processing on the basis of model parameters of the neural network.

3. The image processing apparatus according to claim 2, further comprising:
a similarity calculation unit that calculates an image similarity between a first mixed feature amount related to first image data generated by the feature amount mixing unit and a second mixed feature amount related to second image data generated by the feature amount mixing unit; and
a parameter update unit that updates an image similarity parameter included in the model parameters on the basis of the image similarity calculated by the similarity calculation unit.

4. The image processing apparatus according to claim 2, further comprising:
a text generation unit that generates generated text data by projecting the image feature amount extracted by the image understanding unit onto a vector space of the attached text data; and
a parameter update unit that updates a text generation probability parameter included in the model parameters on the basis of the attached text data and the generated text data generated by the text generation unit.

5. The image processing apparatus according to claim 1, further comprising:
a text generation unit that generates generated text data by projecting the image feature amount extracted by the image understanding unit onto a vector space of the attached text data; and
wherein, when the attached text data is not attached to the image data, the text understanding unit extracts the text feature amount by using the generated text data generated by the text generation unit as the attached text data.

6. The image processing apparatus according to claim 4, wherein the parameter update unit updates the text generation probability parameter on the basis of a loss based on the image feature amount and the attached text data and a loss based on the image feature amount and the generated text data.

7. The image processing apparatus according to claim 4, wherein the parameter update unit updates the text generation probability parameter such that a text feature amount of the attached text data and a text feature amount of the generated text data for image data of the same class approach each other, and updates the text generation probability parameter such that a text feature amount of the attached text data and a text feature amount of the generated text data for image data of different classes move away from each other.

8. The image processing apparatus according to claim 4, wherein the text generation unit uses both generation of the generated text data by random sampling from a predetermined number of high-order tokens at each of times and generation of the generated text data at a normal time.

9. The image processing apparatus according to claim 4, wherein the text understanding unit extracts the text feature amount by performing weighted pooling using a probability that indicates a likelihood of a predetermined-order token related to the generated text data.

10. A communication system comprising:
at least one processor; and
memory storing instructions that, when executed by the at least one processor, causes the system to perform a set of operations, the set of operations comprising:
transmitting image data via a communication network and receiving image classification result data based on image similarity.

11. An image processing method executed by an image processing apparatus for extracting a feature amount of image data, the image processing method comprising:
by the image processing apparatus,
vectorizing an image pattern of the image data to extract an image feature amount;
vectorizing a text pattern of attached text data attached to the image data to extract a text feature amount; and
generating a mixed feature amount as the feature amount by projecting the image feature amount extracted and the text feature amount extracted onto the same vector space and mixing the image feature amount and the text feature amount.

12. (canceled)

13. The communication system of claim 10, wherein the communication network further communicates with a communication terminal, in which the communication terminal displays or prints classification result data.

14. The image processing method of claim 11, wherein the image feature amount is a vector and used as an initial input for a neural network.

15. The image processing method of claim 11, wherein the image feature amount is projected onto a vector space of the text data and generates text data for a query.

16. The image processing method of claim 11, the method further comprising:
vectorizing the text pattern of an accompanying text data of a query data to extract the text feature amount for the query; and
vectorizing the text pattern of an accompanying text data of a support data to extract the text feature amount for support.

17. The image processing method of claim 11, wherein the text data is converted into vectors using a language model.

18. The image processing method of claim 16, wherein the query text data is extracted onto a same vector space by mixing the image feature amount for the query and the text feature amount for the query.

19. The image processing method of claim 16, wherein a supporting query text data is extracted onto a same vector space by mixing the image feature amount for the supporting data and the text feature amount for the supporting data.

20. The image processing method of claim 16, wherein a pair of query data is generated by combining the image data and the accompanying text data.

21. The image processing method of claim 20, wherein the generated pair is used as an input to train a machine learning model.
